(19) United States
(12) Patent Application Publication
(10) Pub. No.: US 2014/0299800 A1
(43) Pub. Date: Oct. 9, 2014

(54) Gas Bottle Valve Provided With A Flywheel Controlling A Residual-Pressure Valve And A Stop Valve

(71) Applicant: LUXEMBOURG PATENT COMPANY S.A., Lintgen (LU)

(72) Inventors: Morgan Lamiable, Metzervisse (FR); Adrien Zoda, Zoufftgen (FR); Jean-Claude Schmitz, Heisdorf (LU)

(73) Assignee: LUXEMBOURG PATENT COMPANY S.A., Lintgen (LU)

(21) Appl. No.: 14/358,584

(22) PCT Filed: Nov. 14, 2012
(86) PCT No.: PCT/EP2012/072632

§ 371 Date: May 15, 2014

(30) Foreign Application Priority Data
Nov. 15, 2011 (LU) LU91901

(51) Int. Cl. F17C 13/04

(52) U.S. Cl. CPC F17C 13/04
USPC 251/33

(57) ABSTRACT

The invention relates to a valve for a gas cylinder pressure. It includes a body with a gas inlet, a gas outlet and a gas passage connecting the net to the outlet. The valve comprises a residual pressure holding disposed at the gas passage. It also comprises a valve for closing the gas passage downstream of the residual pressure holding. A flywheel control valve acts on the valve and on the holding device via a residual pressure control rod and, respectively. The steering wheel includes sliding tracks for the control rods. It comprises a first position of the bottle filling device where the residual pressure holding is turned off and the valve is open, a second dosed position of the bottle where the holding device is active residual pressure valve and is closed, and a third operative position where the holding device is active residual pressure and the valve is opened.

### CROSS-REFERENCE TO RELATED APPLICATIONS

The present invention is the US national stage under 35 U.S.C. §371 of International Application No. PCT/EP2012/072632, which was filed on Nov., 14, 2012 and which claims the priority of application LU 91901 filed on Nov. 15, 2011 the content of which (text, drawings and claims) are incorporated here by reference in its entirety.

### FIELD

The invention relates in particular to a valve or tap for a gas cylinder, in particular a valve for such gas cylinder equipped with a function of holding a residual pressure.

### BACKGROUND

Valves for gas cylinder valves are now commonly equipped with a residual pressure device. The residual pressure is typically of the order of a few bars (for example 3 bars or 44 psi). This device prevents the penetration of impurities by potential reflux in the bottles in use, or by contact with the atmosphere in the bottles which are not connected and where the valve remains open.

This type of device usually consists of a calibrated check valve arranged upstream of the valve tap. This valve is arranged so that resilient means exert a closing force, the valve being configured such that the high pressure inside the bottle readily pushes the valve to open when there is a flow rate demand. When stopping the flow, the valve closes, preventing reflux. When the bottle is nearly empty so that the pressure within it is lower than the setting pressure required to open the valve, no gas can be withdrawn. With the valve remaining permanently closed, the contents of the bottle remains isolated from the outside even when the tap is open.

When filling the gas cylinder via the tap, the residual pressure device, by its construction, will naturally remain dosed. It is therefore necessary to force it open to allow filling of the bottle.

Patent document U.S. Pat. No. 5,048,565 discloses a tap for a gas cylinder, provided with a closing valve, a residual pressure device and a safety valve. The residual pressure device can be actuated in the open position for filling via an opening device controlled pneumatically or mechanically (e.g. via a lever or external tool).

Patent document EP 0372279 A1 discloses a residual pressure device which can be brought into the open position by rotation of an actuating member according to a quarter turn. The valve and the actuating member are equipped with a cam device for converting the rotational movement of the actuating member into a translation movement of the valve.

The actuation for opening a residual pressure device as disclosed in the two above mentioned documents is in principle reserved for qualified personnel to fill bottles. It is indeed important that the device cannot be opened outside of the filling operations. The opening of the device requires a special procedure such as a connection to auxiliary compressed air or as the intervention of special tools.

Patent document U.S. Pat. No. 3,820,560 discloses a scuba bottle tap comprising a residual pressure device with a control lever. The latter is rotatable and acts on a shaft provided with cam profiles acting on a corresponding piece itself acting on the movable part of the residual pressure device. The actuating lever is used to force the device in its open position. It should be noted that the device has a movable seat which allows the filling of the bottle without opening the device with the lever. While the lever allows easy opening of the device but no security is provided to prevent opening of the device when the bottle is in use. The tap of this teaching is foreseen to provide a reserve supply of oxygen during diving. When the actuating lever is designed to give access to this reserve.

The technical problem to be solved by the invention is to provide a tap for a gas cylinder fitted with a residual pressure device and whose filling operation is facilitated.

### SUMMARY

The invention relates to a valve for pressurized gas, particularly for a gas cylinder comprising: a body with an inlet, an outlet and a passage connecting the net with the outlet; a device for maintaining a residual to the input when the pressure valve is in use, the device being disposed in the passage between the net and the outlet; a rotary actuator disposed on the body, configured to control the forced opening of the holding device of residual pressure to deactivate; characterized in that it further comprises: a separate auxiliary device of the residual pressure holding; and in that the rotating control element comprises at least one track configured to control the rotation of the control device can control the residual pressure holding device and the auxiliary.

The holding device is active when residual pressure ensures its function of maintaining residual pressure. In service flow, it is open. When there is no flow but a sufficient pressure in the bottle, it can be either open or dosed, depending on its construction. It is inactive when it is forced open.

The valve may be dimensioned for a gas pressure of more than 50 bar, more particularly of more than 100 bars.

According to various embodiments of the invention, the control member has a rotatable generally disc-shaped, and is preferably disposed outside the body.

The rotary actuator may be plastic. Body and/or rotary actuator may include indexing means.

The body and/or the rotary actuator may comprise blocking means to a particular position such that the filling position.

According to other advantageous embodiments of the invention, the body comprises a circular groove on which the rotary actuator is clipped.

According to yet other advantageous embodiments of the invention, the auxiliary device is a device for closing the passage, preferably disposed downstream of the residual pressure holding.

According to yet other advantageous embodiments of the invention, the rotary actuator comprises a first position of the bottle filling device where residual pressure holding position is forced open (that is to say disabled), and preferably the closure is opened; a second closed position of the bottle where the means of residual pressure holding is active and the closure device is closed; a third operating position in which the retaining device is active residual pressure and the closure device is open; the first, second and third positions being preferably consecutive relative to the rotation of the rotary actuator.

According to yet other advantageous embodiments of the invention, the rotary actuator comprises a first track for controlling the device for maintaining residual pressure and a second track for the auxiliary controlling device, the first track and/or the second track preferably having recesses corresponding to the stop positions and configured to generate at the level of a rotary actuator stop positions of said felt.

According to yet other advantageous embodiments of the invention, the holding device and the auxiliary residual pressure device each comprise an element movable in translation in directions at least substantially parallel, the control member being rotatable about an axis of rotation at least substantially parallel to these directions.

According to yet other advantageous embodiments of the invention, the valve body includes an inlet fitting with gas from a main axis, and a longitudinal axis generally parallel to the main axis of said connector, the directions of translation of mobile elements of the residual pressure holding the auxiliary device and being at least substantially perpendicular to said longitudinal axis.

According to yet other advantageous embodiments of the invention the valve stern comprises a first control device for maintaining residual pressure, cooperating with the track or tracks of the rotary actuator.

According to yet other advantageous embodiments of the invention, the valve comprises a second control rod of the auxiliary device that cooperates with a track or tracks of the rotating control element, the second rod being disposed at least substantially parallel to the first rod.

Advantageously, the first and second rod are disposed on either side of an axis of rotation of the rotary actuator.

According to yet other advantageous embodiments of the invention, the auxiliary device comprises a shutter cooperating with a seat and normally in contact with said seat by elastic means in a direction corresponding to that of gas when the valve is in service, the second control rod being configured to move the shutter in a direction opposite to the direction of the force exerted by the elastic means direction.

According to yet other advantageous embodiments of the invention, the first and/or the second control rod comprises/each comprise an abutment limiting its movement in the opposite order to that direction.

According to yet other advantageous embodiments of the invention, the first and/or the second control rod comprises/each comprise a contact portion with the or one of the control tracks of the rotatable control, or the contact portions projecting from the body normally.

According to yet other advantageous embodiments of the invention, the holding device comprises a residual pressure valve cooperating with a preferably fixed seat, and normally placed in contact with said seat by elastic means in a direction corresponding to that of gas when the valve is in service.

According to yet other advantageous embodiments of the invention, the valve includes a first portion cooperating with the seat and having a first section and a second portion of a second upper section to the first section, the first and second body portions defining with the first high-pressure chamber in contact with the valve inlet, the second portion including sealing means cooperating with a corresponding surface.

According to yet other advantageous embodiments of the invention, the second portion of the shutter with the body defines a second chamber in contact with the body passageway downstream of the first portion and the seat via a channel of the shutter.

The steps of the invention have the advantage of providing a control device for maintaining residual pressure coordinated with an auxiliary device such as a valve opening/closing of the valve. Thus, the holding device of residual pressure may remain normally closed during normal operation of the service valve (provided that the holding device residual pressure opens automatically when there is a demand for gas flow). In addition, the construction is very simple and easy to implement.

### DRAWINGS

FIG. 1 is a view in plan of a valve of the gas bottle, according to various embodiments of the invention.

FIG. 2 is a sectional view of the valve of FIG. 1 along the axis 2-2, according to various embodiments of the invention.

FIG. 3 is a longitudinal sectional view of the valve of FIG. 1, according to various embodiments of the invention.

FIG. 4 is an isometric view of the wheel valve of FIGS. 1 to 3, according to various embodiments of the invention.

### DETAILED DESCRIPTION

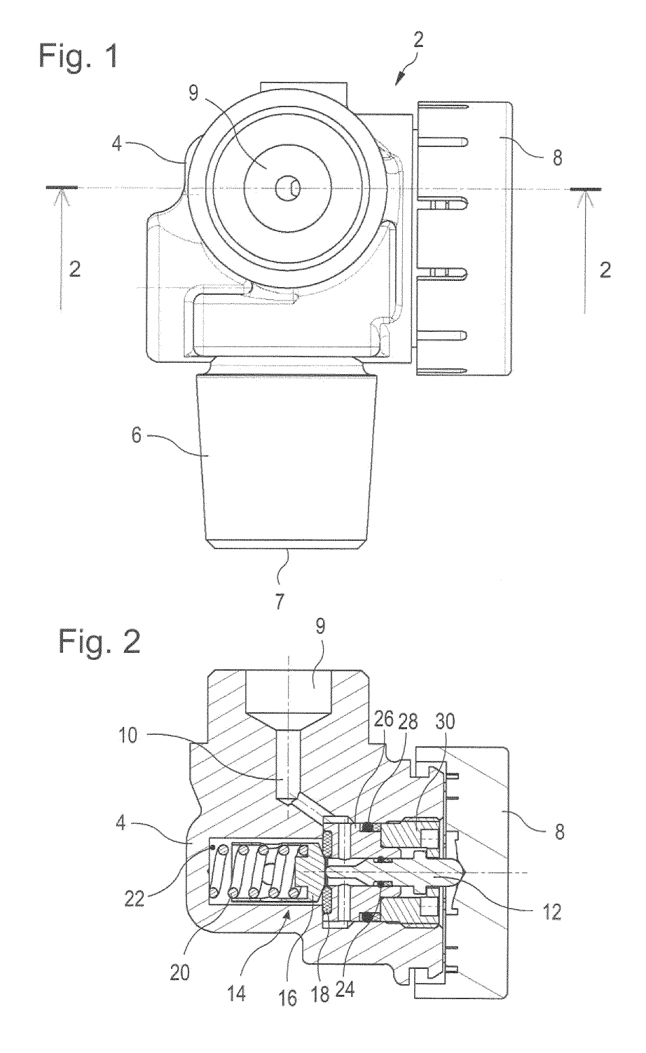

FIG. 1 illustrates a valve for a gas cylinder according to the invention. Valve 2 includes a body 4, preferably generally solid. The body 4 comprises a connection nipple 6 to a gas cylinder (not shown). This fitting is in the form of tapered male thread and corresponds to an input 7 of the valve 2. The body 4 also comprises a gas outlet 9. The valve 2 is provided with a steering wheel 8 arranged laterally on the body 4. This steering wheel 8 is a driving control device of a residual pressure holding valve and a tap.

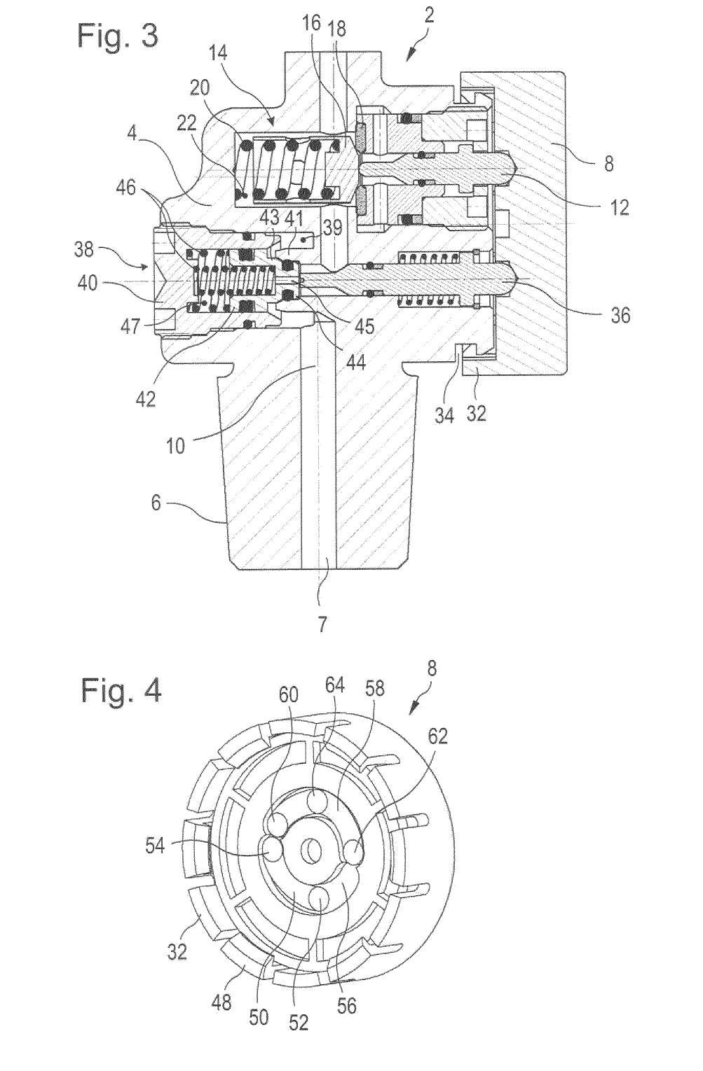

FIG. 2 is a sectional view along line 2-2 of FIG. 1, illustrates the interior of the upper valve. As shown in FIG. 2, the body 4 contains a valve for closing the passage 10 connecting the gas inlet (FIG. 1, reference 7) with the outlet 9. The body 4 comprises a chamber 22 connected to the input 7 (FIG. 1) via a holding device residual pressure (FIG. 3, reference 38). The chamber 22 contains a shutter 16 kept pressed against a seat 18 by a spring 20. Spring 20 rests on the bottom of the chamber 22. The seat 18 consists of a pellet with a central hole, in suitable providing a seal with the shutter 16. The latter can be made of metallic material and the seat 18 may be of plastics material such as e.g. nylon. The seat 18 is sandwiched between a shoulder formed in the body 4 and a valve seat carder 26 held under pressure against the shoulder by a clamping member 30 screwed into a cavity 30 of the body 4. A seal 28 so that optionally an anti-extrusion ring is provided between the seat support 26 and its housing in the body 4. This is a static seal, since the seat support 26 is stationary. The seat support 26 comprises a central bore extending along its principal axis. This bore houses a control rod 12 of the shutter 16 of the valve 14. The control rod 12 includes a groove with a seal 24, and optionally an anti-extrusion ring so as to seal with the bore of the seat carrier 26 wherein it is housed. Sealing is dynamic because the control rod is able to move in translation along its main axis. It also includes a shoulder adapted to abut against a corresponding shoulder of the damping piece 30. One end (to the left according to FIG. 2) is in front of the shutter 16 and a second end (right as shown in FIG. 2) out of the body 4 of the valve and cooperates with a shaped surface of the flywheel 8.

The valve 14 is configured so that the shutter 16 is disposed on the upstream side of the seat 18 and the spring 20 normally maintains the pressure against the seat 18. Thus, the valve 14 closes naturally and the cylinder pressure also exerts pressure on the closure member 16 facing the seat 18. As will be explained in more detail in connection with FIGS. 3 and 4, the rotation of the steering wheel 8 in order to open the valve 14 will moving the control rod 12 toward the plug 16 so as to move it away from its seat 18 and allow the passage of gas from the chamber 22 to the outlet 9. In the dosed position of the valve, corresponding to that shown in 2, the control rod 12 is not brought in pressure between the contoured surface of the steering wheel 8 and the front face of the shutter 16, so as to ensure a satisfactory seal and to allow the packing or caulking seat depending on the pressure and the number of cycles and/or age of the valve. In other words, in the closed position of the valve 14, the control rod 12 has at least one of its ends at a distance from its respective contact surface adapted in a mechanical clearance.

FIG. 3 is a longitudinal sectional view of the valve of FIG. 1 Illustrates the inside of the valve. The passage 10 formed in the body 4 connects the input 7 to the output (not visible in this Figure but in FIG. 2, reference 9). The passage 10 opening upwardly of the valve body 4 is in direct communication with the chamber containing the valve 14. It can be intended to be connected to a manometer. It is noted that the tap illustrated in FIGS. 1 to 3 is incomplete at its upper part.

The body 4 contains a device for maintaining residual pressure in the cylinder 38. The latter is disposed at the passage 10 connecting the net 7 to the outlet 9 of the valve, upstream of the valve 14. It essentially comprises a shutter 43 cooperating with a seat 41, similar to valve 14 with the important difference however that for the shutter 43 defines a first variable volume chamber 39 upstream of the seat 41. The shutter 43 comprises a first end portion 44 cooperating with the seat 41 of the valve body 4, and a second portion 42 slidably sealingly with wall of the body 4. This wall can be formed by an insert piece 40 in a bore of the body, as illustrated in FIG. 3. The second portion 42 has a higher portion than the first section 44, which allows at the application of pressure from the cylinder to generate a resultant force on the shutter 43 facing the second portion 42. This force is opposed to the force of the spring or springs 46 arranged between the screwed part 40 and the face of the shutter 43 corresponding to the second portion 42. The elastic force of the springs 46 and the difference in section between the first and second portions are sized to permit movement of the shutter 43 and thus opening of the gas passage from a given pressure. This minimal pressure for opening the retaining device may be residual pressure in the order of a few bars, for example 3 bar. This pressure corresponds to the pressure there will be residual in the bottle when the contents thereof have been consumed and no longer charge gas.

A channel 45 formed in the valve 43 connects chamber 39 with a second gas passage 10 immediately downstream of the shutter 43. The second chamber 39 is defined by the housing of the shutter 43 and the rear face corresponding to the second portion 42. If you try to fill the bottle without first opening the device for maintaining residual pressure, the filling pressure will build in chamber 39 which has an effective area corresponding to the second portion 42 of the shutter 43, said section being higher than the first portion 44. This then results in a force on the shutter facing in the direction of closure of the latter.

A control rod 36 is partially disposed in the gas passage 10 immediately downstream of the seat 41 and the shutter 43 of the holding device 38 of residual pressure. This control rod command is similar to the control rod 12 of valve 14. It is slidably mounted in a bore of the body 4, parallel to the control rod 12. She also has a shoulder intended to cooperate with a corresponding shoulder of the body 4, so as to limit its movement in the direction of closing the remaining holding device 38. A spring is also provided to assist the displacement of the rod 36 towards the steering wheel 8. A sealing means such as a sealing gasket, possibly with an anti-extrusion ring, are provided in a groove of the control rod 36, so as to provide a seal with the bore of the body 4. One end of the control rod 36 is in facing relation to the first portion 44 of the shutter 43 and a second end is in contact with a profile surface of the flywheel 8. Similarly to the valve 14, the control rod 36 is sized to allow the device to work residual pressure holding correctly despite possible matting contact surfaces between the seat 41 and the shutter 43. For this purpose, a mechanical clearance is provided between the first end (the left according to FIG. 3) of the control rod 36 and the shutter 43 when the steering wheel is in a position not acting on the retaining device of residual pressure. The backlash may be between 0.1 mm and 2 mm, preferably between 0.1 and 1 mm, more preferably between 0.1 and 0.5 mm.

As shown in FIG. 4 illustrating the wheel 8 in perspective, the latter comprises a main disc shaped portion and a skirt formed by a series of sections 32 and 48 some of which 48 are provided with a portion hook intended to cooperate with a groove 34 (FIG. 3) formed on the body 2.

The inner face of the disc-shaped portion 8 of the flywheel comprises two tracks. A first track 50 is intended to cooperate with the control rod 36 of the retaining device of residual pressure. It comprises a sliding surface for the corresponding end of the control rod 36, the sliding surface having an inclined so as to move the control rod upon rotation of the steering wheel 8 profile. The first track 50 includes two hollow items or rest for the corresponding end of the control rod 36.

A first recess 52 corresponds to a first position of the control rod 36 where it does not control the device for maintaining residual pressure. This corresponds to a first hollow portion of the track profile which is the lowest or distance to the valve body. A second recess 54 corresponds to a second position of the control rod 36 where it causes the opening of the holding device of residual pressure. The second corresponds to a hollow portion of the track profile which is the highest or near the body of the valve.

The first track 50 also includes a clearance zone 56 extending the track from the first recess 52. This clearance shall be designed not to move the rod corresponding control.

A second track 58 is intended to cooperate with the control stem 12 of the valve 14. Similarly to the first track, the second track 58 comprises a sliding surface for the corresponding end of the control rod 12, this surface slide having an inclined profile so as to move the control rod 12 upon rotation of the steering wheel 8. It comprises three hollow or resting points for the corresponding end of the control rod 12. A first recess 64 disposed at a central portion of the layer forming a lower most portion of the track path. The recess corresponds to a first position where the steering wheel is not operated valve, that is to say is normally closed. A second recess 60 and a third recess 62 are arranged, respectively, at the ends of the track 58. These end portions correspond to high or close the valve body. The second and third recesses correspond to positions of the steering wheel where the valve is actuated, that is to say is set to the open state.

The first recess 52 of the first track 50 and the first recess 64 of the second path corresponds to a dosed position of the valve, that is to say a position where the valve device and the residual pressure holding are normally closed. In the case of illustrations of FIGS. 1 to 4 the control rods 12 and 36 are diametrically opposed with respect to the center of rotation of the steering wheel 8, so that the first recesses 52 and 64 of first and second tracks are also diametrically opposite.

The second recess 54 of the first track 50 and the third recess 62 of the second track 58 corresponding to a position of filling the bottle. Indeed, the second hollow 54 of the first track 50 will force the opening of the holding device of the residual pressure and the third recess 62 of the second track 58 provides opening of the valve 14. Note that opening of the valve 14 is normally not necessary given its construction in the form of valve that can be opened naturally to filling pressure. As shown in FIGS. 2 and 3, the closing spring 20 of the shutter 16 of the valve 14 is powerful enough to ensure a particular level of security and satisfactory sealing valve. The pressure and hence the flow rate resulting therefrom, the gas exiting the valve during filling may be substantially reduced to the passage of the valve 14 in the absence of forced opening of the latter. This is why a valve opening 14 is provided at the filling of the bottle.

The second recess 60 of the second track 58 and the clearance 56 of the first track 50 corresponding to a position of the valve. In fact, the hollow 60 provides a second displacement of the control rod of the valve opening while forcing the relief area 56 of the first track 50 ensures an undisturbed operation of the residual pressure holding.

The first and second tracks are concentric and describe each, about half a circle. In the specific case described in connection with the figures, the two paths have substantially the same radius. They could, however, have different radii. In this case, the tracks could describe more than a semicircle. The positioning of the control rods of the valve device and the residual pressure holding both sides of the center of rotation of the steering wheel 8 allows a balancing of the pressures exerted by the rods on the steering wheel 8. It is however possible to provide that the control rods are arranged in a lower area at 180°, specifically 90° or even aligned on a radius.

It is also noted that the presence of depressions on the slopes or the steering wheel is not mandatory. It ensures resting positions with felt at the manual control of the steering wheel. We can also provide indexing means separate the wheel and one or more continuous tracks without abrupt change in profile at resting points.

The steering wheel has therefore three positions:

A first position where the bottle filling device of the residual pressure holding is deactivated, that is to say in position forced open, and the valve is open;

A second closed position of the bottle where the retaining device is active residual pressure and the valve is closed;

A third operating position in which the retaining device is active and residual pressure valve is open; said holding residual pressure opening in the presence of a sufficient pressure in the bottle.

The first, second and third positions are consecutive with respect to the rotation of the rotary actuator.

It should be noted that the valve of the invention is not exclusively intended to be mounted on a gas cylinder. It can in fact be mounted on the particular body or pressurized gas lines.

### LIST OF REFERENCE SYMBOLS

2: tap

4: body

6: Input connection for bottle

7: gas net

8: flying

9: gas outlet

10: the gas

12: (first) control rod of the valve

14: valve

16: shutter valve

18: seat

20: valve spring

22: valve chamber

24: the first joint rod

26 seat support

28: joint

30: clamp the seal support

32: skirt flying

34: body groove

36: (second) of the control rod retention device of residual pressure

38: holding device residual pressure

39: first chamber of the residual pressure holding

40: screwed part of the valve

41: seat retainer residual pressure

42: second portion of the shutter device of the residual pressure holding

43: device shutter residual pressure holding

44 first portion of the shutter device of the residual pressure holding

45: channel shutter device residual pressure holding

46: spring

47: second chamber of the residual pressure holding

48: skirt hook steering wheel

50: (first) of the runway maintenance device residual pressure

52: first detent recess of said first track, in the normally dosed position of the holding device residual pressure

54: second catch recess of the first track in the open position of the residual pressure holding

56: clearance zone of the first track

58: (second) track of the valve

60: second detent recesses of he second track, corresponding to an open valve position

62: third detent recess of the second track, corresponding to an open valve position

64: first detent recess of the second track, corresponding to a closed valve position

1.-16. (canceled)

17. A valve for pressurized gas, said valve comprising:
a body with an inlet, an outlet and a passageway connecting the inlet to the outlet;
a holding device for maintaining residual pressure at the net when the valve is in use, the holding device being disposed in the passage between the net and the outlet;
a rotary actuator disposed on the body, configured to control a forced opening of the holding device of residual pressure to deactivate; and
a separate auxiliary device of the residual pressure holding device, wherein the rotary actuator comprises at least one track configured to control the rotation of the rotary actuator can control the residual pressure holding device and the auxiliary device.

18. The valve according to claim 17, wherein the rotary actuator has a generally disc-shaped

19. The valve according to claim 18, wherein the rotary actuator is disposed outside the body.

20. The valve according to claim 18, wherein the body comprises a circular groove on which the rotary actuator is clipped.

21. The valve according to claim 20, wherein the auxiliary device is a device for closing the passage.

22. The valve according to claim 21, wherein the auxiliary device is disposed downstream of the residual pressure holding device.

23. The valve according to claim 21, wherein the rotatable control comprises:
a first position where a bottle filling device of the residual pressure holding is forced to an open position, and a closure device is open;
a second closed position of the bottle where a means of residual pressure holding is active and the closure device is closed; and
a third operating position in which the retaining device is active residual pressure and the closure device is open, wherein the first, second and third positions are consecutive relative to the rotation of the rotary actuator.

24. The valve according to claims 23, wherein the rotating control element comprises a first path for controlling the device for maintaining residual pressure and a second track for the auxiliary controlling device, at least one of the first track and the second track having recesses corresponding to the stop positions and configured to generate at the level of a rotary actuator stop positions of the felt.

25. The valve according to claim 24, wherein the holding device and the auxiliary residual pressure device each comprise an element movable in translation in directions at least substantially parallel, the controller being rotatable about an axis of rotation at least substantially parallel to these directions.

26. The valve according to claim 25, wherein the valve body comprises a gas inlet connection with a main axis, and a longitudinal axis generally parallel with the main axis of said connector, the directions of translation of the movable elements the holding device and the auxiliary residual pressure device being at least substantially perpendicular to said longitudinal axis.

27. The valve according to claim 26 further comprising a first control rod of the retaining device of residual pressure, cooperating with at least one track of the rotary actuator.

28. The valve according to claim 27 further comprising a second control rod of the auxiliary device cooperates with a track or tracks of the rotary actuator, the second rod being disposed at least substantially parallel to the first rod.

29. The valve according to claim 28, wherein the auxiliary device comprises a shutter cooperating with a seat and normally in contact with the seat by elastic means in a direction corresponding to that of gas when the valve is in service, second control rod being configured to move the shutter in a direction opposite to the direction of the force exerted by the elastic means direction.

30. The valve according to claim 29, wherein at least one of the first and the second control rod comprises an abutment limiting its movement in the opposite order to that direction.

31. The valve according to claim 30, wherein at least one of the first and the second control rod comprises a contact portion with at least one:
at least one of the tracks of the control member rotary actuator, and
the contact portions projecting from the body normally.

32. The valve according to claim 31, wherein the holding device comprises a residual pressure valve cooperating with a fixed seat, and normally placed in contact with the seat by an elastic means in a direction corresponding that of the gas when the valve is in service.

33. The valve according to claim 32, wherein the closure device comprises a first portion cooperating with the seat and having a first section and a second section of a second portion greater than the first section, the first and second portions defining a first body with the high pressure chamber in contact with the valve inlet, the second portion including sealing a means for cooperating with a corresponding surface.

34. The valve according to claim 33, wherein the second portion of the shutter with the body defines a second chamber in contact with the body passageway downstream of the first seat portion and the channel via a shutter.
